(19) United States
(12) Patent Application Publication
(10) Pub. No.: US 2009/0107446 A1
(43) Pub. Date: Apr. 30, 2009

(54) Apparatus for the operation of a work object

(76) Inventor: Dennis M. Dehaas, Hanford, CA (US)

Correspondence Address: Rodney K. Worrel;WORREL & WORREL, St. Croix Professional Center, 2109 W. Bullard Avenue, Suite 121, Fresno, CA, 93711-1258, US

(21) Appl. No.: 11/982,178

(22) Filed: Oct. 31, 2007

(51) Int. Cl. F02B 39/00

(52) U.S. Cl. 123/188.4

(57) ABSTRACT

An apparatus for the operation of a work object, in which the work object has a chamber adapted to receive a work material for the performance of an operation of the work material and converting the work material into a resulting substance and the apparatus has a first passage adapted to supply the work material to the chamber; a second passage adapted to release the resulting substance from the chamber; and a pair of slideable members individually moveable relative to the first passage and the second passage to control the operation in the chamber.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

(1) Field of the Invention

The present invention relates to an apparatus for the operation of a work object and, more particularly, to such an apparatus which controls the operation of a work object with a precision, simplicity and dependability superior to that heretofore achieved in the art.

(2) Description of the Prior Art

A myriad of work objects, such as various devices, systems and the like, have been developed over centuries to advance the performance, improve the reliability, reduce the size and otherwise to improve upon prime movers, such as internal combustion engines and many other types of devices. Such efforts have not appreciably attained their objectives; that is, deficiencies, inadequacies and the like have continued to plague such efforts.

One of the most prevalent of these inadequacies is associated with control of the flow of fluids, whether in a gaseous or liquid form or some combination thereof. Control of such fluids in an attempt to achieve the desired result has been replete with difficulties including, but not limited to, unreliable operation, particularly under unfavorable circumstances. For example, an increase or decrease in ambient temperature and/or the operational temperature may convert the gas into a liquid or the liquid into a gas. This occurrence usually renders the device inoperable, at least for as long as the adverse condition persists. Similarly, the complexity and necessity of extremely rapid movement of subassemblies and operative parts during operation over time may cause failures thereof, heat increase and seizing of operative parts which can, of course, cause the destruction of the work object.

Another significant problem exists in the loss of power and performance due to the complexity of the subsystems and parts required for operation. More specifically, the output of the device is reduced in direct relation to the number and/or complexity of subsystems and/or operable parts required for its operation. Typically, this is a consequence of friction loss and other factors due to the interoperation thereof. Thus, a substantial deficiency in such work objects is the inherent loss of performance during operation of the work object. Where increased performance is achieved in a particular device, such as by increase in the size thereof, it is at the expense of what otherwise would, theoretically, be the optimum performance of the device.

For example, in a prime mover, such as an internal combustion engine, there is a loss of torque and horsepower, an increase in operational temperature and the like due to the complexity of the subsystems and elements conventionally required for operation. This necessitates a larger engine to achieve the same production as would otherwise, theoretically, be possible with a smaller engine where these conditions did not exist, or were less substantial. The only other manner of achieving improved performance under such circumstances is the use of performance enhancing systems which have their own attendant adverse consequences. An internal combustion engine has substantial deficiencies in these and other respects as a result of such factors.

Therefore, it has long been known that it would be desirable to have an apparatus for the operation of a work object which alleviates many of the deficiencies associated with the operation of conventional work objects; which has particular utility when used with respect to prime movers such as internal combustion engines; which substantially reduces the number of subsystems and moving parts required for operation; which alleviates the deficiencies associated with conventional devices; which avoids the complexity inherent in conventional devices; which operates with a precision, simplicity and dependability not heretofore achieved in the art; and which is otherwise entirely successful in achieving its operational objectives.

### BRIEF SUMMARY OF THE INVENTION

Therefore, it is an object of the present invention to provide an improved apparatus for the operation of a work object.

Another object is to provide such an apparatus which has application to a wide variety of work objects in the operation thereof and which constitutes a substantial improvement over conventional systems and devices.

Another object is to provide such an apparatus which has particular utility when employed relative to an internal combustion engine, or similar prime movers.

Another object is to provide such an apparatus which does not require the use of a multiplicity of subsystems and operable parts such as required in conventional devices.

Another object is to provide such an apparatus which achieves enhanced performance and dependability of use for a given size and weight of work object under operational conditions which are more severe than those in which conventional devices are capable of operating.

Another object is to provide such an apparatus which is uniquely well suited to use in the operation of an internal combustion engine avoiding the necessity for using the multiplicity of subsystems and operative parts required by conventional devices.

Another object is to provide such an apparatus which achieves enhanced performance when compared to conventional devices of substantially the same size.

Another object is to provide such an apparatus which substantially reduces the friction loss and other detrimental effects during operation so as to minimize the reduction of performance inherent in the operation of conventional devices.

Another object is to provide such an apparatus which can be set for use within parameters not heretofore achieved in the art so as to be adaptable for use on a wide variety of work objects.

Further objects and advantages are to provide improved elements and arrangements thereof in an apparatus for the purposes described which is dependable, economical, durable and fully effective in accomplishing its intended purposes.

These and other objects and advantages are achieved, in the preferred embodiment of the present invention, in an apparatus for the operation of a work object, in which the work object has a chamber adapted to receive a work material for the performance of an operation of the work material and converting the work material to a resulting substance, the apparatus has a first passage adapted to supply a work material to the chamber; a second passage adapted to release the resulting substance from the chamber; and a pair of slideable members individually moveable relative to the first passage and the second passage to control the operation in the chamber.

### BRIEF DESCRIPTION OF THE SEVERAL VIEWS OF THE DRAWINGS

FIG. 1 is a partial diagrammatic view combined with a partial vertical section of the apparatus for the operation of a work object of the present invention.

FIG. 2 is a somewhat enlarged, fragmentary, horizontal section of the valve assemblies of the present invention taken on line 2-2 in FIG. 1.

### DETAILED DESCRIPTION OF THE INVENTION

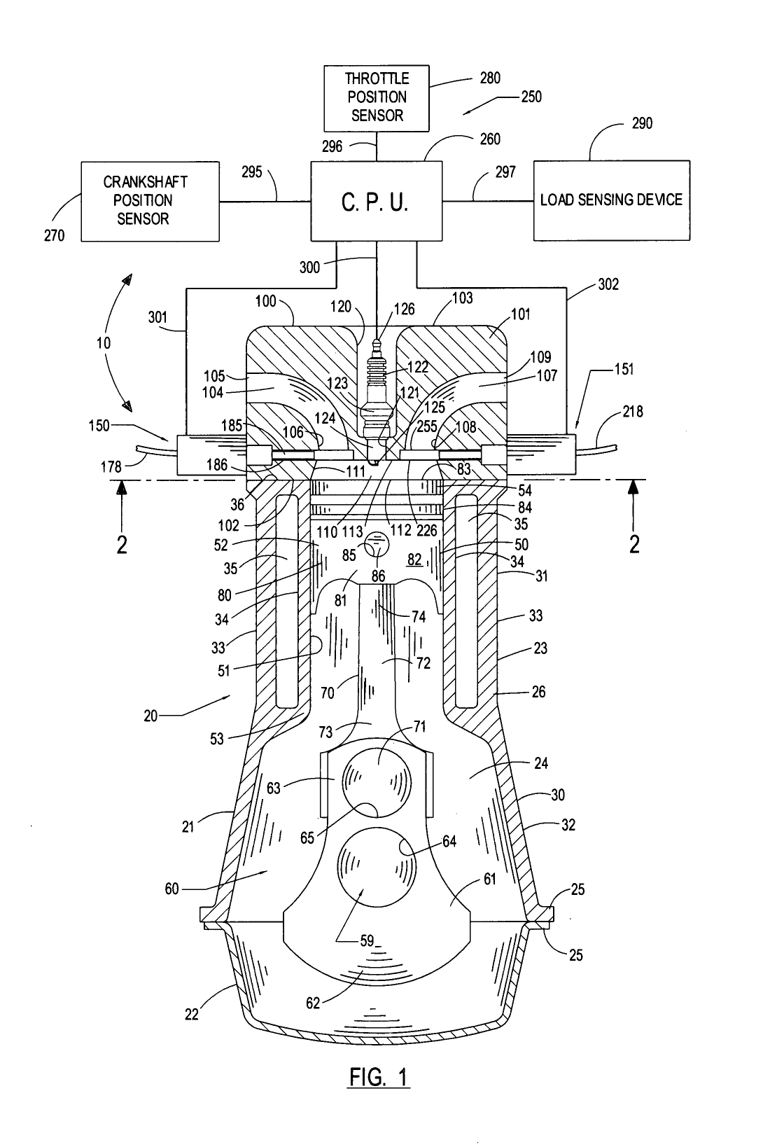

Referring more particularly to the drawings, the apparatus for the operation of a work object of the present invention is generally indicated by the numeral 10 in FIG. 1.

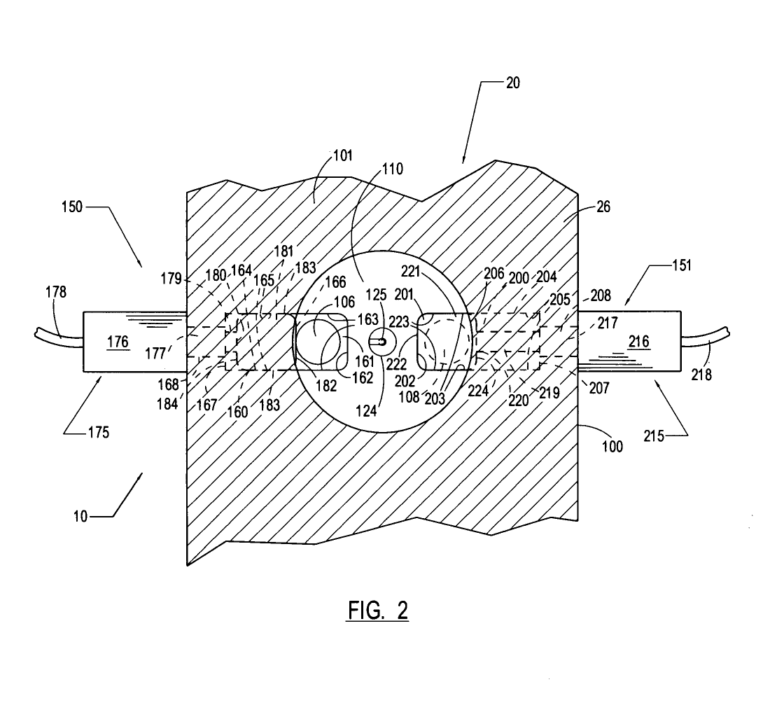

The apparatus 10 of the present invention can be employed in the operation of a wide variety of work objects. The specific type of work object with which the apparatus is used will, to some extent, be determinative of the precise form and mode of operation of the apparatus. In the preferred embodiment of the apparatus shown and described herein, the work object is an internal combustion engine generally indicated by the numeral 20 in FIGS. 1 and 2.

The internal combustion engine 20 has a crankcase 21 composed generally of a lower housing 22 and an upper housing 23. The crankcase has an interior 24. The lower and upper housings have mounting flanges 25 which are disposed in facing engagement and are held in this position by nut and bolt assemblies, not shown. For illustrative convenience, gaskets, seals and the like are not shown, but it is to be understood that conventional parts of this type are employed as necessary and in accordance with conventional construction. The lower housing 22 and the upper housing 23 can be viewed as constituting an engine block 26.

The upper housing 23 of the crankcase 21 has, generally, a lower portion 30 and an upper portion 31. The lower portion has a downwardly flared walls 32. The upper portion 31 has outer walls 33 which are substantially parallel to each other, as shown in FIG. 1. The upper portion of the upper housing has interior walls 34 which are substantially parallel to each other and to the outer walls 33. Each outer wall and interior wall have portions spaced from each other to define a coolant duct 35 therebetween. It will be understood that the coolant ducts extend through the engine block 26 for cooling of the internal combustion engine in the conventional manner. The upper portion 31 of the upper housing 23 has a flat terminal surface 36.

The upper housing 23 of the crankcase 21 has an engine cylinder generally indicated by the numeral 50. The engine cylinder is bounded by a cylindrical cylinder surface 51 in the upper portion 31 of the upper housing. The engine cylinder has an upper end portion 52 and an opposite lower end portion 53. The engine cylinder has an upper cylinder opening 54 which extends through the flat terminal surface 36 of the upper portion 31.

A crankshaft is generally indicated by the numeral 59 in FIG. 1. The crankshaft 59 is mounted within the interior 24 of the crankcase 21. It will be understood that, as in a conventional internal combustion engine, the crankshaft 59 extends longitudinally through the crankcase and is operable to be reciprocated by a plurality of piston assemblies in their respective cylinders in the designed sequence of movement during operation of the internal combustion engine.

More specifically, a crankshaft assembly 60 is mounted on the crankshaft 59. A crankshaft assembly is generally indicated by the numeral 60 in FIG. 1 mounted on the crankshaft within the interior 24 of the crankcase 21. The crankshaft assembly has a crankshaft body 61 mounted on the crankshaft, as shown in FIG. 1 and as hereinafter be described. The crankshaft body has an enlarged weighted portion 62 and a pivot portion 63. The crankshaft body has a bearing assembly 64 through which the crankshaft rotationally extends. Similarly, the crankshaft body 61 has a piston rod bearing assembly 65.

The internal combustion engine 20 has a plurality of piston assemblies therewithin. For illustrative convenience, only one such piston assembly, generally indicated by the numeral 70, is shown and described herein. The piston assembly has a piston rod journal 71 mounted for rotational movement in the piston rod bearing assembly 65. A connecting rod assembly 72 is mounted on the piston rod journal 71 for movement therewith. More specifically, the connecting rod assembly has a lower portion 73 which is mounted on the piston rod journal and an opposite upper portion 74.

A piston 80 is mounted on the upper portion 74 of the connecting rod assembly 72. The piston has a cylindrical piston body 81 having an outer cylindrical surface 82 and an upper surface 83. A plurality of piston rings 84 are mounted on and extend about the piston body outwardly from the outer cylindrical surface 82 and into engagement with the cylinder surface 51 of the engine cylinder 50. A piston pin passage 85 extends through the piston body. A piston pin 86 extends through the piston pin passage 85 and through the upper portion 74 of the connecting rod assembly 72 pivotally to mount the piston body on the upper portion of the connecting rod assembly.

The piston body 81 is thus mounted in operative connection with the crankshaft 59 for reciprocal movement of the piston body within the engine cylinder 50.

A cylinder head assembly 100 is mounted on the engine block 26. The cylinder head assembly has a cylinder head body 101 having a lower surface 102 and an upper surface 103. The lower surface of the cylinder head body defines a flat plane which facingly engages the flat terminal surface 36 of the upper portion 31 of the upper housing. The lower surface is retained in such facing engagement by bolts, not shown, removably to retain the lower surface and upper surface in sealing relation.

An intake passage 104 extends arcuately through the cylinder head body 101 from an intake port 105 to a cylinder port 106. An exhaust passage 107 extends arcuately through the cylinder head body from a cylinder port 108 to an exhaust port 109. A combustion chamber is generally indicated by the numeral 110 and is bounded by an upwardly tapering cylindrical surface 111. The cylindrical surface has a lower edge 112 and an upper surface 113. The intake port 105 of the intake passage communicates with the exterior of the cylinder head body for connection to a fuel and air source, not shown. The exhaust port 109 communicates with the exterior of the cylinder head body for connection to an exhaust system, not shown. The cylinder ports 108 and 109 of the respective intake passage 104 and exhaust passage 107, communicate with the combustion chamber 110. As will become more clearly apparent, due to the area both within the cylinder head assembly 100 and externally thereof as a result of the present invention, the intake and exhaust passages and their respective intake port, cylinder port and exhaust port can be extended through the cylinder head assembly in virtually any preferred positions. In other words, the fact that the apparatus of the present invention does not use many of the operative components required by a conventional internal combustion engine, such as a timing belt or chain; cam shaft and cam gear; valve lifters; conventional valves; push rods; rocker arms; valve springs; valve spring retainers; retainer locks; and other conventional equipment; there is substantially more space available for receiving and mounting components in a wide variety of different positions.

A spark plug passage 120 extends inwardly of the cylinder head body 101 and communicates with the combustion chamber 110 through a spark plug port 121. A spark plug 122 has a spark plug body 123. The spark plug body has a spark plug head 124 received in sealing relation within the spark plug port 121. A spark plug igniter is mounted on the spark plug head and extends a very short distance into the combustion chamber 110. At its opposite end, the spark plug body 123 has an upward by extending spark plug terminal 126.

Turning then, more specifically, to the apparatus 10 of the present invention, the apparatus has a left sliding valve or control assembly 150 and a right sliding valve or control assembly 151, as perhaps best shown in FIG. 2. As will subsequently be discussed in greater detail, the left control assembly 150 and the right control assembly 151 are operated separately from each other or together within the internal combustion engine 20 in place of conventional valves in accordance with the present invention. In other words, the apparatus 10 of the present invention does not employ conventional valves in the internal combustion engine.

The left control assembly 150 has a control passage 160 extending from a predetermined position within the cylinder head body 101 into the upper end portion 52 of the engine cylinder 50 and into communication with the cylinder port 106 of the intake passage 105. The control passage has a recessed portion 161 which faces downwardly toward the piston 80 within the engine cylinder 50. The recessed portion of the control passage has a terminal wall 162 and lateral walls 163. The control passage has a slotted portion 164 defined by lateral walls 165, a mouth 166 and a terminal wall 167. The mouth 166 directly communicates with the recessed portion 161 through the cylindrical surface 111 of the combustion chamber 110. A solenoid mounting passage 168 extends into the cylinder head body 101 and communicates with the control passage 160 through the terminal wall 167 of the slotted portion 164 of the control passage.

A left solenoid assembly 175 is mounted on the cylinder head body 101 and has a main housing 176. A mounting cylinder 177 is mounted on the main housing and is received in the solenoid mounting passage 168 and is mounted therein and thereby on the cylinder head body 101. An electrical power cable 178 is operably mounted on the main housing 176 in electrically supplying relation thereto. The left solenoid assembly has a control shaft 179 operably extending through the mounting cylinder from the main housing. The control shaft 179 extends through the mounting cylinder into the slotted portion 164 of the control passage for reciprocal movement therewithin under the control of the main housing 176 of the left solenoid assembly 175. The control shaft has a terminal end 180.

A substantially flat control member 181 is mounted on the terminal end 180 of the control shaft 179 for slidable movement in the control passage 160 from a retracted position, substantially fully received in the slotted portion 164 of the control passage, to an extended position, substantially fully received in the recessed portion 161 in sealing relation to the cylinder port 106 of the intake passage 104. The control member 181 has a terminal edge 182, lateral edges 183 and a trailing edge 184. The control member has an upper surface 185 and a lower surface 186.

The right control assembly 151 has a control passage 200 extending from a predetermined position within the cylinder head body 101 into the upper end portion 52 of the engine cylinder 50 and into communication with the cylinder port 108 of the exhaust passage 107. The control passage has a recessed portion 201 which faces downwardly toward the piston 80 within the engine cylinder 50. The recessed portion of the control passage has a terminal wall 202 and lateral walls 203. The control passage has a slotted portion 204 defined by lateral walls 205, a mouth 206 and a terminal wall 207. The mouth 206 directly communicates with the recessed portion 201 through the cylindrical surface 111 of the combustion chamber 110. A solenoid mounting passage 208 extends into the cylinder head body 101 and communicates with the control passage 200 through the terminal wall 207 of the slotted portion 204 of the control passage.

A right solenoid assembly 215 is mounted on the cylinder head body 101 and has a main housing 216. A mounting cylinder 217 is mounted on the main housing and is received in the solenoid mounting passage 208 and mounted therein and thereby on the cylinder head body 101. An electrical power cable 218 is operably mounted on the main housing 216 in electrically supplying relation thereto. The right solenoid assembly has a control shaft 219 operably extending through the mounting cylinder from the main housing. The control shaft 219 extends through the mounting cylinder into the slotted portion 204 of the control passage for reciprocal movement therewithin under the control of the main housing 216 of the right solenoid assembly 215. The control shaft has a terminal end 220.

Although, in the preferred embodiment, as heretofore described, the left control assembly 150 and the right control assembly 151 are electric and electrical, they could also be of any other suitable type such as pneumatic, hydraulic, mechanical or the like.

A substantially flat control member 221 is mounted on the terminal end 220 of the control shaft 219 for slidable movement in the control passage 200 from a retracted position, substantially fully received in the slotted portion 204 of the control passage, to an extended position, substantially fully received in the recessed portion 201 in sealing relation to the cylinder port 106 of the intake passage 104. The control member 221 has a terminal edge 222, lateral edges 223 and a trailing edge 224. The control member has an upper surface 225 and a lower surface 226.

Referring more particularly to FIG. 1, the apparatus 10 has a control system generally indicated by the numeral 250 therein. In the preferred embodiment disclosed herein, the control system 250 is electronic. However, the control system, if preferred, can be hydraulic, pneumatic, or any other suitable type of control system.

The control system 250 has a central processing unit (C.P.U.) 260 which is shown diagrammatically in FIG. 1. The central processing unit is, in large part, a computer which is adapted and programmed to operate the control system as hereinafter described. The central processing unit houses the internal storage, processing, control circuitry hardware and software, not shown, of the control system.

It will be understood, however, that the central processing unit 260 can be constructed in a wide variety of different forms for operation in a multitude of different modes of operation to accomplish the operations herein described relative to this preferred embodiment of the subject invention. The present invention is not to be limited to a specific type or structure of central processing unit nor is the control system 250 of this preferred embodiment of the subject invention so limited in any respect.

The location of the central processing unit 260 as well as the other components of the control system 250 hereinafter to be described can be mounted in any suitable locations relative to other portions of the work object. Thus, for example, in order to avoid the central processing unit being subjected to the heat produced by the internal combustion engine and other deleterious conditions and substances during operation, the central processing unit can be mounted in a position remote from the internal combustion engine and otherwise protected from damage or malfunction.

The control system 250 has a crankshaft position sensor 270, a trottle position sensor 280 and a load sensing device 290, as shown in FIG. 1. The crankshaft position sensor is operably connected to the central processing unit 260 by a signal cable 295. The trottle position sensor is operably connected to the central processing unit by a signal cable 296. The load sensing device is operably connected to the central processing unit by a signal cable 297.

The central processing unit 260 is operably connected to the spark plug terminal 126 of the spark plug 122 by a control cable 300. The central processing unit is operably connected to the left solenoid assembly 175 by a control cable 301. The central processing unit is operably connected to the right solenoid assembly 215 by a control cable 302.

### Operation

The operation of the described embodiment of the subject invention is believed to be clearly apparent and is briefly summarized at this point.

The work object in the preferred embodiment of the subject invention is an internal combustion engine 20. This is, however, only one such type of work object and is representative of a wide variety of types of work objects upon which the apparatus 10 can be employed. In the preferred embodiment, the internal combustion engine can be used in an automotive vehicle, boat, aircraft, industrial engine, or any other type work object. In the disclosed application, for illustrative convenience, the internal combustion engine can be visualized as employed in an automotive vehicle, not shown.

In use, operation of the internal combustion engine 20 of the automotive vehicle is initiated in the conventional manner utilized in the automotive vehicle, such as turning the ignition, not shown, to an “on” position. At this time, the central processing unit 260 operates the left control assembly 150 and the right control assembly 151. The central processing unit places the control member 181 of the left control assembly in an open position; that is, with the control shaft 179 in a fully retracted position within the control passage 160. This slides the control member 181 to a fully retracted position within the control passage 160. The central processing unit slides the control member 221 of the right control assembly 151 to a closed position; that is, with the control shaft 219 in a fully extended position within the control passage 200. This slides the control member 221 to a fully extended position within the control passage 200. Thus, at this time the cylinder port 106 of the intake passage 104 is in a fully open position communicating with the combustion chamber 110. At the same time, the cylinder port 108 of the exhaust passage 107 is in a fully closed and sealed position.

A charge of a fuel and air mixture produced by the automotive vehicle is passed into the combustion chamber 110 through the open cylinder port 106 by a carburetor, fuel injector, or other means, not shown, of the automotive vehicle. Thereafter, the central processing unit 260, by means of the left control assembly 150, slides the control member 181 to the fully closed and sealed position shown in FIG. 1. The combustion chamber is thereby fully sealed by the control members 181 and 221, respectively, as well as by the upper surface 83 of the piston 80.

The central processing unit 260 thereafter operates the spark plug 122 to ignite the fuel and air mixture within the combustion chamber 110. The fuel and air mixture explodes within the combustion chamber, causing the piston 80 to be forced downwardly in the engine cylinder 50. This energy is transferred to the crankshaft 59 by the piston rod 71 and connecting rod assembly 72. The crankshaft is thereby rotated three hundred and sixty degrees (360°) through the medium of this engine cylinder 50 and the other engine cylinders of the internal combustion engine, not shown. This energy is passed in the normal manner from the crankshaft to drive the automotive vehicle through the otherwise normal operative components, not shown.

As the crankshaft 59 rotates in the described manner, the piston 80 is moved first downwardly in the engine cylinder 59 and then upwardly to the position shown in FIG. 1. At the same time, the central processing unit 260 operates the right control assembly 151 to slide the control member 221 thereof to a fully retracted position thus opening the cylinder port 108.

As the piston 80 moves upwardly in the engine cylinder 50, the gases created, by the prior explosion of the fuel and air mixture, are expelled from the combustion chamber 110. These gases are thus forced through the open cylinder port 108 and from the internal combustion engine 20 through the exhaust passage 107 and exhaust port 109.

As the piston 80 approaches the upper position shown in FIG. 1, the central processing unit 260 operates the right control assembly 151 to slide the control member 221 to the fully closed and sealed position shown in FIG. 1. As the piston approaches the upper most position in the engine cylinder 50, the central processing unit 260 operates the left control assembly 150 to slide the control member 181 to the fully open position to permit another charge of the fuel and air mixture to the combustion chamber 110 and then to close and seal the control member 181 to entrap the new charge of the fuel and air mixture in the combustion chamber. At this time, the control members 181 and 221 respectively are both in the fully closed and sealed positions shown in FIG. 1. The charge of fuel and air mixture is then compressed by the piston and ignited by the spark plug. 122.

This cycle is rapidly and continuously repeated to drive the internal combustion engine 20 and thus the automotive vehicle. The central processing unit 260 receives information from the crankshaft position sensor 270, the throttle position sensor 280 and the load sensing device 290 so that the central processing unit controls operation of the internal combustion engine 20 so as to provide the desired performance thereof. The central processing unit can be adjusted to control operation of the internal combustion engine for the desired performance therefrom.

The apparatus 10 of the present invention possesses a myriad of improvements over the prior art, some of which have already been described. The simplicity, dependability, reliability and the like are some, but not all, of these benefits not heretofore achieved in the art. In addition, the apparatus provides advancements relating to the timing of an internal combustion engine or the like. The apparatus permits the achievement of optimal timing for a variety of different operational conditions. These conditions include but are not limited to, achieving optimal timing of the engine for idling, cruising, a wide open throttle, deceleration and many other such conditions. Furthermore, the apparatus operates to permit the engine, and thus the automotive vehicle, to achieve optimal gas mileage, performance, exhaust emissions and the like.

Therefore, the apparatus for the operation of a work object of the present invention is particularly well suited to alleviate many of the deficiencies associated with the operation of conventional work objects; has particular utility when used with respect to prime movers such as internal combustion engines; substantially reduces the number of subsystems and moving parts required for operation; alleviates the deficiencies associated with conventional devices; avoids the complexity inherent in conventional devices; operates with a precision, simplicity and dependability not heretofore achieved in the art; and which is otherwise entirely successful in achieving its operational objectives.

Although the invention has been herein shown and described in what is conceived to be the most practical and preferred embodiment, it is recognized that departures may be made therefrom within the scope of the invention which is not to be limited to the illustrative details disclosed.

Having described my invention, what I claim as new and desire to secure by Letters Patent is:

1. An apparatus for the operation of a work object, in which the work object has a chamber adapted to receive a work material for the performance of an operation on the work material and converting the work material to a resulting substance, the apparatus comprising a first passage adapted to supply said work material to the chamber; a second passage adapted to release said resulting substance from said chamber; and a pair of slideable members individually moveable relative to the first passage and the second passage to control said operation in the chamber.

2. The apparatus of claim 1 in which the work object is an internal combustion engine, the chamber is for the combustion of the work material therewithin and wherein the slideable members are individually movable between opened and closed positions intermediate the first passage and the second passage relative to the chamber.

3. The apparatus of claim 2 wherein a control system is operable individually to move the slideable members between their respective opened and closed positions.

4. The apparatus of claim 3 wherein the control system includes a pair of solenoids individually connected to said slideable members individually to move the slideable members between their respective opened and closed positions.

5. The apparatus of claim 4 wherein said control system has a central processing unit operably connected to the solenoids individually to move the slideable members between said individual opened and closed positions.

6. An apparatus for the operation of a work object, such as an internal combustion engine having at least one cylinder, a piston moveable within the cylinder, a combustion chamber adapted to receive a combustible substance therewithin and an igniting assembly operable to ignite the combustible substance within the combustion chamber, the apparatus comprising, an intake passage extending into communication with the combustion chamber; an exhaust passage extending from communication with the combustion chamber; and means mounted on the internal combustion engine for selective movement substantially transversely of the combustion chamber individually between closed and opened positions relative to said intake passage and said exhaust passage for admitting said combustible substance into the combustion chamber and discharging the material resulting from combustion of said combustible substance in said combustion chamber.

7. The apparatus of claim 6 wherein said means includes a first control member operable to move along a path substantially transversely of said intake passage between opened and closed positions and a second control member operable to move along a path substantially transversely of said exhaust passage between opened and closed positions; and a control system operable individually to move said first control member and said second control member between the respective opened and closed positions to admit said combustible substance to the combustion chamber thereafter to move the first control member to the closed position and to maintain the second control member in the closed position for said combustion in the combustion chamber and thereafter to move the second control member to the opened position to release said material resulting from said combustion from the combustion chamber.

8. The apparatus of claim 7 wherein said paths are slots and the first control member and the second control member are individually mounted in the slots for slideable movement between said respective opened and closed positions.

9. The apparatus of claim 8 wherein said control system includes solenoid assemblies individually operable to move the first control member and the second control member between said opened and closed positions.

10. The apparatus of claim 9 wherein the control system includes a central processing unit individually connected to the solenoid assemblies and operable individually to actuate said solenoids to move said first control member and said second control member between their respective opened and closed positions.

11. The apparatus of claim 10 wherein said first control member and said second control member are substantially flat and are moved along said paths substantially transversely of said combustion chamber.

12. The apparatus of claim 11 wherein the control system includes a crankshaft position sensor, a throttle position sensor and a load sensing device operably connected to the central processing unit and individually operable to provide information to the central processing unit for individual operation of the solenoid assemblies.
